(19) United States
(12) Patent Application Publication
(10) Pub. No.: US 2019/0190792 A1
(43) Pub. Date: Jun. 20, 2019

(54) METHOD AND SYSTEM FOR PROTECTING CDN CLIENT SOURCE STATION

(71) Applicant: WANGSU SCIENCE & TECHNOLOGY CO., LTD., Shanghai (CN)

(72) Inventors: Weicai CHEN, Shanghai (CN); Fengli ZHANG, Shanghai (CN)

(21) Appl. No.: 16/322,179

(22) PCT Filed: Jun. 1, 2017
(86) PCT No.: PCT/CN2017/086806

§ 371 Date: Jan. 31, 2019

(30) Foreign Application Priority Data
Mar. 10, 2017 (CN) 201710140021.7

(51) Int. Cl. H04L 12/24; H04L 29/06

(52) U.S. Cl. CPC H04L 41/147; H04L 41/142; H04L 63/1425; H04L 63/101

(57) ABSTRACT

A method for protecting CDN client source station is provided. The method includes: collecting an indicator parameter from a client source station, and collecting a dimension parameter from a CDN edge node; obtaining source station load data, back-to-source status data, and client behavioral data by processing the indicator parameter and the dimension parameter; analyzing the source station load data, the back-to-source status data, and the client behavioral data to obtain prediction data; determining a source station service status based on the prediction data; when the source station service status is abnormal, determining different abnormal conditions and generating a corresponding control strategy in conjunction with the collected indicator parameter and dimension parameter; and executing the control strategy. Through relatively precise prediction, the source station may be protected in real-time and more accurately. Further, the present disclosure provides a system for protecting CDN client source station.

### FIELD OF THE DISCLOSURE

The present disclosure generally relates to the network technology and, more particularly, relates to a method and system for protecting a CDN client source station.

### BACKGROUND

A CDN (Content Delivery Network) is basically understood to provide web station acceleration and CPU load balancing, thus solving issues such as a slow website opening speed induced by switching of service providers, switching of regions, a too low loading capability of the servers, or a too low bandwidth, etc. The basic principles of the CDN is to avoid bottlenecks and steps in the internet that affect data transmission speed and stability as much as possible, thereby allowing content delivery to be faster and more stable. Via the layer of intelligent virtual network constituted by node servers placed all over the network on basis of the existing internet, the CDN system may re-direct the user request to the server node nearest to the user based on comprehensive information such as the network traffic flow, the connection and loading conditions of each node, the distance from the nodes to the user, and the response time. The objective of the CDN system is enabling the user to obtain the needed content as convenient as possible, solve the situation of Internet congestion, and improve the response speed of the website that the user visits.

The traditional CDN client source station often manually determines whether an attack occurs or the service encounters an issue, or may issue a control command once a corresponding back-to-source bandwidth exceeds a certain threshold to reduce the back-to-source traffic towards the CDN nodes, thereby protecting the client source station. The effectiveness and accuracy of such method are both relatively poor. Further, because the entire network is controlled when protection is provided, differentiation control cannot be carried out for clients in a specific region or for a specific service of the clients to maximally protect the clients' benefits. Further, the existing protection method of the CDN client source stations are mostly protection, which fails to look into the original sources of the occurred issues by analyzing relatively complete practical data in the protection process.

### BRIEF SUMMARY OF THE DISCLOSURE

To solve issues in the existing technology, the present disclosure provides a method and system for protecting CDN client source station. The technical solutions are as follows.

In one aspect, a method for protecting CDN client source station is provided, comprising the following steps:

collecting an indicator parameter from a client source station, and collecting a dimension parameter from a CDN edge node;

obtaining source station load data, back-to-source status data, and client behavioral data by processing the collected indicator parameter and dimension parameter;

analyzing the source station load data, the back-to-source status data, and the client behavioral data to obtain prediction data;

determining a source station service status based on the prediction data;

when the source station service status is abnormal, determining different abnormal conditions, and generating a corresponding control strategy in conjunction with the collected indicator parameter and dimension parameter; and

executing the control strategy.

Further, steps of analyzing the source station load data, the back-to-source status data, and the client behavioral data to obtain prediction data may further comprise:

collecting a real-time access feature of each access IP; and

calculating a correlation feature of different IP sections, and by comparing the correlation feature with historical data, finding a distribution of abnormal access IPs.

Further, after a step of calculating a correlation feature of different IP sections, and by comparing the correlation feature with historical data, finding a distribution of abnormal access IPs, the method includes:

increasing a tracking frequency and impact of an abnormal access IP in a plurality of subsequent data statistic processes; and

starting a protection black-and-white list or a function that limits the number of access times after the tracked abnormal access IP reaches a standard that affects service abnormity.

Further, the indicator parameter includes at least one of an IO consumption and a load consumption.

Further, the dimension parameter includes at least one of a back-to-source bandwidth, a back-to-source request number, current connection data, back-to-source time, a back-to-source status code ratio, and a feature of an IP that requests the source station.

Further, after the step of analyzing the source station load data, the back-to-source status data, and the client behavioral data to obtain prediction data, the method further includes:

performing re-prediction on the prediction data via a prediction mode.

Further, a step of obtaining the prediction data based on the source station load data, the back-to-source status data, and the client behavioral data includes:

performing mean value calculation after de-noising using the collected source station load data, calculating a current status of the source station by comparison with a historical numerical value from a dimension of a source station service ability, and performing calculation on the service ability after de-noising using the collected back-to-source status data.

Further, the step of obtaining the prediction data based on the source station load data, the back-to-source status data, and the client behavioral data includes:

calculating a source station status value=an abnormal score of the back-to-source bandwidth+an abnormal score of the back-to-source request number+an abnormal score of the response time of a back-to-source request+an abnormal score of the responsive status code ratio of the back-to-source request+an abnormal score of a current source station connection number. The higher the source station status value, the poorer the service ability, and the lower the source station status value, the stronger the service ability.

Further, after the step of analyzing the source station load data, the back-to-source status data, and the client behavioral data to obtain prediction data, the method further includes:

performing a re-prediction on the prediction data.

Further, the mode of the prediction is to deduce a subsequent numerical value via a previous value and a current value and based on multi-dimensional data such as back-to-source time of a CDN node, a responsive status code ratio, and a current actual normal or abnormal connection number, thereby obtaining relatively accurate prediction data. Further, the source station service status may be determined based on the prediction data.

In another aspect, a system for protecting CDN client source station is provided. The system includes a client source station, a CDN edge node, a proxy server, and a strategy generator. The proxy server includes a data collecting unit and a control strategy executing unit. The strategy generator includes a data analyzing unit, a prediction data generating unit, a status determining unit, and a control strategy generating unit.

The data collecting unit is configured to collect an indicator parameter from a client source station and collect a dimension parameter from a CDN edge node.

The data analyzing unit is configured to obtain source station load data, back-to-source status data, and client behavioral data by processing the collected indicator parameter and dimension parameter.

The prediction data generating unit is configured to obtain prediction data after analyzing the source station load data, the back-to-source status data, and the client behavioral data.

The status determining unit is configured to determine a source station service status based on the prediction data.

The control strategy generating unit is configured to, when the source station service status is abnormal, determine different abnormal conditions, and generate a corresponding control strategy in conjunction with the collected indicator parameter and dimension parameter.

The control strategy executing unit is configured to execute the control strategy.

Further, the prediction data generating unit includes:

an access feature collecting module, configured to collect a real-time access feature of an access IP of each visitor;

an IP distribution calculating module, configured to calculate a correlation feature of different IP sections, and by comparing the correlation feature with historical data, find a distribution of abnormal access IPs.

Further, the prediction data generating unit further includes;

a data tracking module, configured to increase a tracking frequency and impact of an abnormal access IP in a plurality of subsequent data statistic processes; and

an abnormal processing module, configured to start a protection black-and-white list or a function that limits a number of access times after a standard that affects service abnormity is reached.

Further, the indicator parameter includes at least one of an IO consumption and a load consumption.

Further, the dimension parameter includes at least one of a back-to-source bandwidth, a back-to-source request number, current connection data, back-to-source time, back-to-source status code ratio, and a feature of an IP that requests the source station.

Further, the prediction data generating unit is further configured to perform re-prediction on the prediction data via a prediction mode.

Beneficial effects of the technical solutions provided by embodiments of the present disclosure include: collecting an indicator parameter from a client source station, and collecting a dimension parameter from a CDN edge node; obtaining source station load data, back-to-source status data, and client behavioral data after processing the collected indicator parameter and the dimension parameter; analyzing the source station load data, the back-to-source status data, and the client behavioral data to obtain prediction data; determining the source station service status based on the prediction data; when the source station service status is abnormal, generating a corresponding control strategy in conjunction with the collected indicator parameter and dimension parameter; and executing the control strategy. Via a relatively precise prediction, protection of the source station may be more timely and accurate. Under conditions when the source station service encounters an issue, the service quality of the client may be maximally ensured via differentiation configuration. Through analysis of big data, the reason that causes the issue of the source station service may be found as much as possible, and whether the source station is truly stable and is able to fully recover service may be automatically and more reality determined.

### BRIEF DESCRIPTION OF THE DRAWINGS

To more clearly illustrate the technical solution in the present disclosure, the accompanying drawings used in the description of the disclosed embodiments are briefly described hereinafter. Obviously, the drawings described below are merely some embodiments of the present disclosure. Other drawings derived from such drawings may be obtainable by those ordinarily skilled in the relevant art without creative labor.

FIG. 1 is a flow chart of a method for protecting CDN client source station according to Embodiment 1 of the present disclosure;

FIG. 2 is a flow chart of a method for protecting CDN client source station according to Embodiment 2 of the present disclosure;

FIG. 3 is a structural schematic view of a system for protecting CDN client source station according to Embodiment 3 of the present disclosure; and

FIG. 4 is a structural schematic view of a system for protecting CDN client source station according to Embodiment 4 of the present disclosure.

### DETAILED DESCRIPTION

To more clearly describe the objectives, technical solutions and advantages of the present disclosure, embodiments of the present disclosure will be made in detail with reference to the accompanying drawings hereinafter.

### Embodiment 1

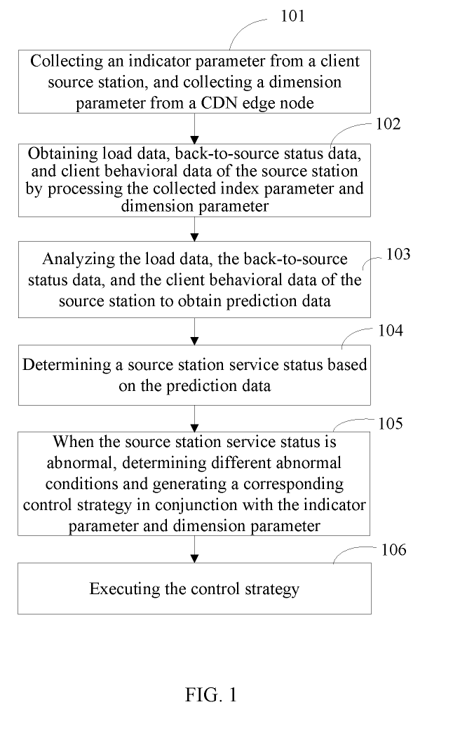

Referring to FIG. 1, Embodiment 1 of the present disclosure provides a method for protecting CDN client source station, comprising Step 101˜Step 106, as described in detail hereinafter.

In Step 101, an indicator parameter is collected from a client source station, and a dimension parameter from a CDN edge node is collected.

The indicator parameter includes at least one of an IO consumption and a load consumption. The dimension parameter includes at least one of a back-to-source bandwidth, a back-to-source request number, current connection data, back-to-source time, a back-to-source status code ratio, and a feature of an IP that requests the source station.

More specifically, the client source station provides an API interface, and invokes the API interface periodically, thereby collecting and establishing with a client the indicator parameter that feedbacks a service ability of the source station. The CDN edge node provide an API interface, and invokes the API interface periodically, thereby collecting various dimension parameters of the CDN edge node.

In Step 102: source station load data, back-to-source status data, and client behavioral data are obtained after processing the collected indicator parameter and dimension parameter.

More specifically, mean value calculation is performed after de-noising using the collected load data of the source station, and a current status of the source station is calculated by comparison with a historical numerical value from a dimension of a service ability of the source station. The service ability is calculated after de-noising using the collected back-to-source status data.

For data of each dimension, a corresponding impact ratio coefficient is configured, different impact ratio coefficients reflect a judging standard of the impact of such data on service stability of an actual client source station, and the sum of different weights is 100. More specifically, an abnormal score of the back-to-source bandwidth=an amplitude that the back-to-source bandwidth deviates from the abnormal value*a weight coefficient of the back-to-source bandwidth. An abnormal score of the back-to-source request number=an amplitude of the abnormal value of the back-to-source request number*a weight coefficient of the back-to-source request number. An abnormal score of the response time of the back-to-source request=an amplitude of the abnormal value of the back-to-source response time*a weight coefficient of the back-to-source response time. An abnormal score of the responsive status code ratio of the back-to-source request=an amplitude of the abnormal value of the responsive status code ratio*a weight coefficient of the responsive status code ratio of the back-to-source request. An abnormal score of a current source station connection number=an amplitude of the abnormal value of the current source station connection number*a weight abnormal coefficient of the current source station connection number. The source station status value=the abnormal score of back-to-source bandwidth+the abnormal score of back-to-source request number+the abnormal score of response time of a back-to-source request+an abnormal score of a responsive status code ratio of the back-to-source request+an abnormal score of a current source station connection number. The higher the source station status value, the poorer the service ability, and the lower the source station status value, the stronger the service ability. It should be noted that, the abnormal points considered by different client source station may be different, and determination may be performed based on actual abnormal points.

In Step 103: the source station load data, the back-to-source status data, and the client behavioral data are analyzed to obtain prediction data.

Further, for the data after statistical analysis, a prediction method may be used again to improve timeliness, and given the load as an example, a function of cubic spline interpolation is used. The first derivative and the second derivative are first obtained, if the rate is positive, the load is indicated to increase, and if the acceleration is negative, the rate is indicated to decrease and finally change to 0. The cubic spline interpolation function may predict relatively complex modes, and is not limited to predict linear modes. The interpolation function may solve the vibration problem: the indicator collection and the reaction delay may indicate that the value is outdated, the interpolation may reduce error, the prediction may be more accurate, and the vibration may be decreased. Via loading, the preset value may be approached. The current predictions are all based on the first three time intervals, and under situations where the time interval is relatively short, the obtained results are almost real-time results.

In Step 104: the source station service status is determined based on the prediction data.

More specifically, a subsequent value is deduced via a previous value and a current value and based on multi-dimensional data such as back-to-source time of a CDN node, a responsive status code ratio, and a current actual normal or abnormal connection number, thereby obtaining relatively accurate prediction data. Further, based on the prediction data, the source station service status may be determined.

In Step 105: when the source station service status is abnormal, generating a corresponding control strategy is generated in conjunction with the collected indicator parameter and dimension parameter.

In particular, the control strategy at least includes a regional control strategy (control is performed with reference to regional features of different IPs), a service control strategy, a black and white name strategy, and an access number restriction strategy.

When the source station service encounters an issue, control is carried out on different aspects including specific IP, specific region of visiting client, and specific client service. Under situations where the service ability of the source station is ensured, effective source station access may be maximally provided, thereby ensuring the client's benefits.

In Step 106: the control strategy is executed.

More specifically, based on the abnormal points fed back by the source station, for different abnormal conditions and major factors that affect the abnormity, different types of control strategies may be generated by integrating the differential demand of the source station client, such as the high-to-low preference of the visiting region, and the high-to-low preference of the source station related service, etc. After the proxy server receives the information, different strategies may be applied to invoke API interfaces that are not used by the CDN edge node to convey the strategy, thereby realizing protection of the source station.

In the disclosed method of protecting the CDN client source station, the indicator parameter is collected from the client source station, and the dimension parameter is collected from the CDN edge node; the collected indicator parameter and dimension parameter are processed to obtain source station load data, back-to-source status data, and client behavioral data; the source station load data, the back-to-source status data, and the client behavioral data are analyzed to obtain prediction data; the source station service status is determined based on the prediction data; when the source station service status is abnormal, a corresponding control strategy is generated by integrating the collected indicator parameter and dimension parameter; and the control strategy is executed. Via a relatively precise prediction, protection of the source station may become more timely and accurate. Under conditions where the source station service encounters an issue, the service quality of the client may be maximally ensured via the differentiation configuration. Through analysis of big data, the reason leading to the issue of the source station service may be found as much as possible, and whether the source station is truly stable and is able to fully recover service may be automatically and more vividly determined.

### Embodiment 2

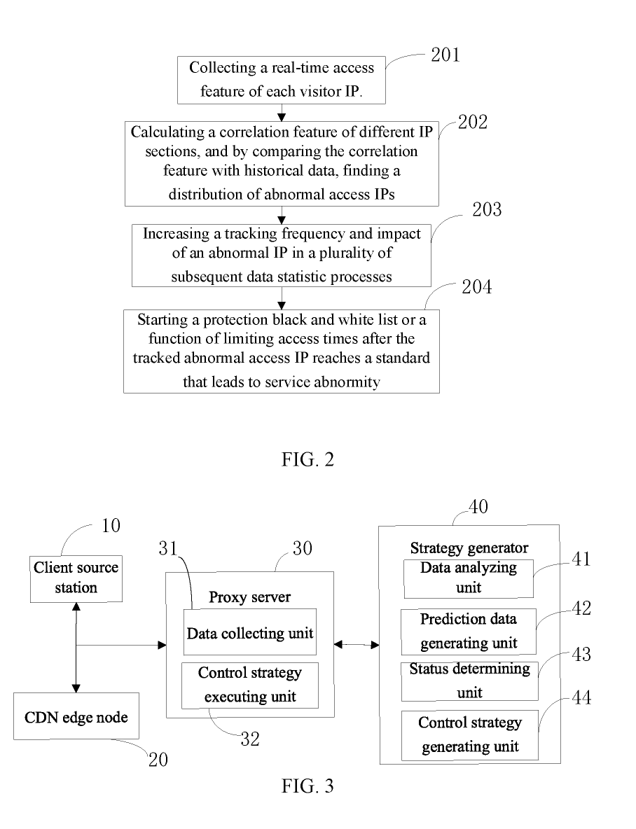

Referring to FIG. 2, Embodiment 2 of the present disclosure provides a method for protecting CDN client source station, comprising Step 201˜Step 204, as described hereinafter in detail.

In Step 201: a real-time access feature of an access IP of each visitor is collected.

The access feature includes at least one of the number of access times, the access time distribution, and the access content.

In Step 202: a correlation feature of different IP sections is calculated, and by comparing the correlation feature with historical data, a distribution of abnormal access IPs is found.

In Step 203: a tracking frequency and impact of an abnormal access IP are increased in a plurality of subsequent data statistic processes.

In Step 204: a protection black-and-white list or a function that limits a number of access times is started after the tracked abnormal access IP reaches a standard that leads to service abnormity.

In the disclosed method for protecting CDN client source station, the real-time access feature of an IP of each visitor is collected; the a correlation feature of different IP sections is calculated, and by comparing the correlation feature with historical data, the distribution of abnormal access IPs is determined; the tracking frequency and impact of an abnormal access IP are increased in a plurality of subsequent data statistic processes; and the protection black-and-white list or a function that limits a number of access times is started after the tracked abnormal access IP reaches a standard that leads to service abnormity, thereby obtaining the prediction data.

### Embodiment 3

Referring to FIG. 3, Embodiment 3 of the present disclosure provides a system for protecting CDN client source station that corresponds to the method for protecting CDN client source station as illustrated in FIG. 1. Accordingly, the details of the method for protecting CDN client source station in Embodiment 1 may be implemented herein, thereby achieving the same effect. The system may include a client source station 10, a CDN edge node 20, a proxy server 30, and a strategy generator 40. The proxy server 30 includes a data collecting unit 31 and a control strategy executing unit 32. The strategy generator 40 includes a data analyzing unit 41, a prediction data generating unit 42, a status determining unit 43, and a control strategy generating unit 44.

The data collecting unit 31 is configured to collect an indicator parameter from a client source station and collect a dimension parameter from a CDN edge node.

The indicator parameter includes at least one of an IO consumption and a load consumption. The dimension parameter includes at least one of a back-to-source bandwidth, a back-to-source request number, current connection data, back-to-source time, a back-to-source status code ratio, and a feature of an IP that requests the source station.

More specifically, the client source station provides an API interface, and invokes the API interface periodically, thereby collecting and establishing with a client the indicator parameter that feedbacks a service ability of the source station. The CDN edge node provide an API interface, and invokes the API interface periodically, thereby collecting various dimension parameters of the CDN edge node.

The data analyzing unit 41 is configured to process the collected indicator parameter and dimension parameter to obtain source station load data, back-to-source status data, and client behavioral data.

More specifically, mean value calculation is performed after de-noising using the collected load data of the source station, and a current status of the source station is calculated by comparison with a historical numerical value from a dimension of a service ability of the source station. The service ability is calculated after de-noising using the collected back-to-source status data.

For data of each dimension, a corresponding impact ratio coefficient is configured, different impact ratio coefficients reflect a judging standard of the impact of such data on service stability of an actual client source station, and the sum of different weights is 100. More specifically, an abnormal score of the back-to-source bandwidth=an amplitude that the back-to-source bandwidth deviates from the abnormal value*a weight coefficient of the back-to-source bandwidth. An abnormal score of the back-to-source request number=an amplitude of the abnormal value of the back-to-source request number*a weight coefficient of the back-to-source request number. An abnormal score of the response time of the back-to-source request=an amplitude of the abnormal value of the back-to-source response time*a weight coefficient of the back-to-source response time. An abnormal score of the responsive status code ratio of the back-to-source request=an amplitude of the abnormal value of the responsive status code ratio*a weight coefficient of the responsive status code ratio of the back-to-source request. An abnormal score of a current source station connection number=an amplitude of the abnormal value of the current source station connection number*a weight abnormal coefficient of the current source station connection number. The source station status value=an abnormal score of back-to-source bandwidth+an abnormal score of back-to-source request number+an abnormal score of response time of a back-to-source request+an abnormal score of a responsive status code ratio of the back-to-source request+an abnormal score of a current source station connection number. Further, the higher the source station status value, the poorer the service ability, and the lower the source station status value, the stronger the service ability. It should be noted that, the abnormal points considered by different client source station may be different, and determination may be performed based on actual abnormal points.

The prediction data generating unit 42 is configured to obtain prediction data after analyzing the source station load data, the back-to-source status data, and the client behavioral data.

Further, for the data after statistical analysis, a prediction method may be used again to improve timeliness. The load is used as an example, and a function of cubic spline interpolation is used. A first derivative and a second derivative are first obtained, if the rate is positive, the load is indicated to increase, and if the acceleration is negative, the rate is indicated to decrease and finally change to 0. The cubic spline interpolation function may predict a relatively complex mode, and is not limited to predict linear modes. The interpolation function may solve the vibration problem: the indicator collection and the reaction delay may indicate that the value is outdated, the interpolation may reduce error, the prediction may be more accurate, and the vibration may be decreased. Via loading, the preset value may be approached. The current predictions are all based on the first three time intervals, and under situations where time interval is relatively short, the obtained results are almost real-time result.

The status determining unit 43 is configured to determine a source station service status based on the prediction data.

More specifically, a subsequent value is deduced via a previous value and a current value and based on multi-dimensional data such as back-to-source time of a CDN node, a responsive status code ratio, and a current actual normal or abnormal connection number, thereby obtaining relatively accurate prediction data. Further, based on the prediction data, the source station service status may be determined.

The control strategy generating unit 44 is configured to, when the source station service status is abnormal, generate a corresponding control strategy in conjunction with the collected indicator parameter and dimension parameter.

In particular, the control strategy at least includes a regional control strategy (control is performed with reference to regional features of different IPs), a service control strategy, a black and white name strategy, and an access number restriction strategy.

When the source station service encounters an issue, control is carried out on different aspects including specific IP, specific region of visiting client, and specific client service. Under situations where the service ability of the source station is ensured, effective source station access may be maximally provided, thereby ensuring the client's benefits.

The control strategy executing unit 32 is configured to execute the control strategy.

More specifically, based on the abnormal points fed back by the source station, for different abnormal conditions and major factors that affect the abnormity, different types of control strategies may be generated by integrating the differential demand of the source station client, such as the high-to-low preference of the visiting region, and the high-to-low preference of the source station related service, etc. After the proxy server receives the information, different strategies may be applied to invoke API interfaces that are not used by the CDN edge node to convey the strategy, thereby realizing protection of the source station.

In the disclosed system for protecting the CDN client source station, the indicator parameter is collected from the client source station, and the dimension parameter is collected from the CDN edge node; the collected indicator parameter and dimension parameter are processed to obtain source station load data, back-to-source status data, and client behavioral data; the source station load data, the back-to-source status data, and the client behavioral data are analyzed to obtain prediction data; the source station service status is determined based on the prediction data; when the source station service status is abnormal, a corresponding control strategy is generated by integrating the collected indicator parameter and dimension parameter; and the control strategy is executed. Via a relatively precise prediction, protection of the source station may become more timely and accurate. Under conditions where the source station service encounters an issue, the service quality of the client may be maximally ensured via the differentiation configuration. Through analysis of big data, the reason that causes the issue of the source station service may be found to the greatest degree, and whether the source station is truly stable and is able to fully recover service may be automatically and more vividly determined.

### Embodiment 4

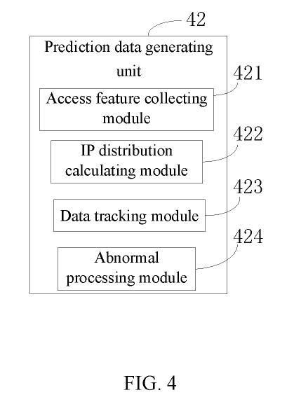

Referring to FIG. 4, Embodiment 4 of the present disclosure provides a system for protecting CDN client source station that corresponds to the multi-tenant network optimization method as illustrated in FIG. 2, thereby realizing details of the method for protecting CDN client source station in Embodiment 1 and achieving the same effects. In the disclosed system for protecting CDN client source station, the prediction data generating unit 42 includes:

an access feature collecting module 421, configured to collect a real-time access feature of an IP of each visitor;

where, the access feature includes at least one of the number of access times, the access time distribution, and the access content.

an IP distribution calculating module 422, configured to calculate a correlation feature of different IP sections, and by comparing the correlation feature with historical data, find a distribution of abnormal access IPs.

a data tracking module 423, configured to increase a tracking frequency and impact of an abnormal access IP in a plurality of subsequent data statistic processes; and

an abnormity processing module 424, configured to start a protection black-and-white list or a function that limits a number of access times after the tracked abnormal IP reaches a standard that leads to service abnormity.

In the disclosed system for protecting CDN client source station, the real-time access feature of each visitor IP is collected; the correlation feature of different IP sections is calculated, and by comparing the correlation feature with historical data, the distribution of abnormal access IPs is found; the tracking frequency and impact of an abnormal access IP are increased in a plurality of subsequent data statistic processes; and the protection black-and-white list or the function that limits a number of access times is started after the tracked abnormal IP reaches a standard that leads to service abnormity, thereby obtaining the prediction data.

The sequence of the embodiments described above is merely for illustrative purposes, and does not represent any preference.

The system embodiments described above are merely for illustrative purpose. The units described as separated parts may or may not be physically detached. The parts displayed as units may or may not be physical units, i.e., may be located at one place, or distributed at a plurality of network units. Based on the actual needs, a part or all of the modules may be selected to achieve the objective of the embodiments. Those ordinarily skilled in the art may understand and implement the disclosed embodiments without contributing creative labor.

Through the descriptions of various aforementioned embodiments, those skilled in the art may clearly understand that the embodiments may be implemented by means of software in conjunction with an essential common hardware platform, or may be simply implemented by hardware. Based on such understanding, the essential part of the aforementioned technical solutions or the part that contribute to the prior art may be embodied in the form of software products. The software products may be stored in computer readable storage media, such as ROM/RAM, magnetic disk, and optical disk, etc., and may include a plurality of instructions to enable a computer device (may be a personal computer, a server, or a network device) to execute the methods described in various embodiments or parts of the embodiments.

The foregoing are merely certain preferred embodiments of the present disclosure, and are not intended to limit the present disclosure. Without departing from the spirit and principles of the present disclosure, any modifications, equivalent substitutions, and improvements, etc. shall fall within the scope of the present disclosure.

1. A method for protecting CDN client source station, comprising:
collecting an indicator parameter from a client source station, and collecting a dimension parameter from a CDN edge node;
obtaining source station load data, back-to-source status data, and client behavioral data by processing the indicator parameter and the dimension parameter;
analyzing the source station load data, the back-to-source status data, and the client behavioral data to obtain prediction data;
determining a source station service status based on the prediction data;
when the source station service status is abnormal, determining different abnormal conditions, and generating a corresponding control strategy in conjunction with the collected indicator parameter and dimension parameter; and
executing the control strategy.

2. The method according to claim 1, wherein a step of analyzing the source station load data, the back-to-source status data, and the client behavioral data to obtain prediction data comprises:
collecting a real-time access feature of an access IP of each visitor; and
calculating a correlation feature of different IP sections, and by comparing the correlation feature with historical data, finding a distribution of abnormal access IPs.

3. The method according to claim 2, wherein after calculating a correlation feature of different IP sections, and by comparing the correlation feature with historical data, finding a distribution of abnormal access IPs, the method includes:
increasing a tracking frequency and impact of an abnormal access IP in a plurality of subsequent data statistic processes; and
starting a protection black-and-white list or a function that limits a number of access times after the tracked abnormal access IP reaches a standard that leads to service abnormity.

4. The method according to claim 2, wherein the indicator parameter includes at least one of an IO consumption or a load consumption.

5. The method according to claim 1, wherein the dimension parameter includes at least one of a back-to-source bandwidth, a back-to-source request number, current connection data, back-to-source time, a back-to-source status code ratio, or a feature of an IP that requests the client source station.

6. The method according to claim 5, wherein a step of obtaining prediction data based on the source station load data, the back-to-source status data, and the client behavioral data includes:
performing a mean value calculation after de-noising using the collected source station load data;
calculating a current status of the client source station via a comparison with a historical numerical value from a dimension of a service ability of the client source station; and
performing a calculation on the service ability after de-noising using the collected back-to-source status data.

7. The method according to claim 6, wherein the step of obtaining prediction data based on the source station load data, the back-to-source status data, and the client behavioral data includes:
performing a calculation: a source station status value=an abnormal score of the back-to-source bandwidth+an abnormal score of the back-to-source request number+an abnormal score of the back-to-source time+an abnormal score of the back-to-source status code ratio+an abnormal score of a current source station connection number,
wherein a higher source station status value indicates a poorer service ability, and a lower the source station status value indicates a stronger service ability.

8. The method according to claim 1, wherein after the step of analyzing the source station load data, the back-to-source status data, and the client behavioral data to obtain prediction data, the method further includes:
performing a re-prediction on the prediction data.

9. The method according to claim 8, wherein a method of re-prediction includes:
deducing a subsequent numerical value via a previous value and a current value and based on multi-dimensional data including a back-to-source time of a CDN node, a responsive status code ratio, and a current actual normal or abnormal connection number, thereby obtaining more accurate prediction data, and
determining the source station service status based on the prediction data.

10. A system for protecting CDN client source station, comprising:
a client source station,
a CDN edge node,
a proxy server, and
a strategy generator, the proxy server including a data collecting unit and a control strategy executing unit, and the strategy generator including a data analyzing unit, a prediction data generating unit, a status determining unit, and a control strategy generating unit, wherein:
the data collecting unit is configured to collect an indicator parameter from a client source station and collect a dimension parameter from a CDN edge node;
the data analyzing unit is configured to obtain source station load data, back-to-source status data, and client behavioral data by processing the collected indicator parameter and dimension parameter;
the prediction data generating unit is configured to obtain prediction data after analyzing the source station load data, the back-to-source status data, and the client behavioral data;
the status determining unit is configured to determine a source station service status based on the prediction data;
the control strategy generating unit is configured to, when the source station service status is abnormal, determine different abnormal conditions, and generate a corresponding control strategy in conjunction with the collected indicator parameter and dimension parameter; and
the control strategy executing unit is configured to execute the control strategy.

11. The system according to claim 10, wherein the prediction data generating unit includes:
an access feature collecting module, configured to collect a real-time access feature of an IP of each visitor; and
an IP distribution calculating module, configured to calculate a correlation feature of different IP sections, and by comparing the correlation feature with historical data, find a distribution of abnormal access IPs.

12. The system according to claim 11, wherein the prediction data generating unit further includes:
a data tracking module, configured to increase a tracking frequency and impact of an abnormal access IP in a plurality of subsequent data statistic processes; and
an abnormal processing module, configured to start a protection black-and-white list or a function that limits a number of access times after the tracked abnormal IP reaches a standard that leads to service abnormity.

13. The system according to claim 10, wherein the indicator parameter includes at least one of an IO consumption or a load consumption.

14. The system according to claim 10, wherein the dimension parameter includes at least one of a back-to-source bandwidth, a back-to-source request number, current connection data, back-to-source time, a back-to-source status code ratio, or a feature of an IP that requests the source station.

15. The system according to claim 10, wherein the prediction data generating unit is further configured to perform re-prediction on the prediction data using a prediction mode.

16. The method according to claim 7, wherein:
the abnormal score of the back-to-source bandwidth=an amplitude that the back-to-source bandwidth deviates from the abnormal value*a weight coefficient of the back-to-source bandwidth,
the abnormal score of the back-to-source request number=an amplitude of the abnormal value of the back-to-source request number*a weight coefficient of the back-to-source request number,
the abnormal score of the back-to-source time=an amplitude of the abnormal value of the back-to-source response time*a weight coefficient of the back-to-source response time,
the abnormal score of the back-to-source status code ratio=an amplitude of the abnormal value of the responsive status code ratio*a weight coefficient of the responsive status code ratio of the back-to-source request, and
the abnormal score of a current source station connection number=an amplitude of the abnormal value of the current source station connection number*a weight abnormal coefficient of the current source station connection number.

17. The method according to claim 1, wherein a step of determining a source station service status based on the prediction data includes:
deducing a subsequent numerical value via a previous value and a current value and based on multi-dimensional data including a back-to-source time of a CDN node, a back-to-source status code ratio, and a current actual normal or abnormal connection number, thereby obtaining more accurate prediction data, and
determining the source station service status based on the prediction data.

18. The method according to claim 1, wherein the control strategy at least includes a regional control strategy by performing a control with reference to regional features of different IPs, a service control strategy, a black and white name strategy, and an access number restriction strategy.

19. The method according to claim 1, wherein a step of executing the control strategy includes:
based on the abnormal points fed back by the source station, for different abnormal conditions and major factors that affect the abnormity, different types of control strategies are generated by integrating differential demands of the source station client.
